(19) United States
(12) Patent Application Publication
(10) Pub. No.: US 2024/0302762 A1
(43) Pub. Date: Sep. 12, 2024

(54) TWO-COMPONENT DEVELOPER

(71) Applicant: KYOCERA Document Solutions Inc., Osaka (JP)

(72) Inventor: Sho SUMIOKA, Osaka-shi (JP)

(73) Assignee: KYOCERA Document Solutions Inc., Osaka (JP)

(21) Appl. No.: 18/598,569

(22) Filed: Mar. 7, 2024

(30) Foreign Application Priority Data
Mar. 9, 2023 (JP) 2023-036532

(51) Int. Cl. G03G 9/113; G03G 9/08; G03G 9/093; G03G 9/097

(52) U.S. Cl. CPC G03G 9/1136; G03G 9/0819; G03G 9/09342; G03G 9/09741

(57) ABSTRACT

A two-component developer contains a carrier containing carrier particles and a toner containing toner particles. The carrier particles each include a carrier core and a coat layer covering the surface of the carrier core. The coat layers contain a silicone resin. The toner particles each include a toner mother particle and an external additive attached to the surface of the toner mother particle. The external additive contains specific resin particles. The specific resin particles contain a crosslinked resin. The specific resin particles have a number average primary particle diameter of at least 37 nm and no greater than 103 nm. The specific resin particles have a content of at least 0.6 parts by mass and no greater than 1.0 part by mass relative to 100 parts by mass of the toner mother particles.

### INCORPORATION BY REFERENCE

The present application claims priority under 35 U.S.C. § 119 to Japanese Patent Application No. 2023-036532, filed on Mar. 9, 2023. The contents of this application are incorporated herein by reference in their entirety.

### BACKGROUND

The present disclosure relates to a two-component developer.

In electrophotography, two-component developers are used that contain a carrier containing carrier particles and a toner containing toner particles, for example. The two-component developers are required to have the ability (also referred to below as charge stability) to maintain a constant amount of charge of the toner.

In view of the foregoing, use of a carrier as the carrier for the two-component developers is studied that contains carrier particles each including a carrier core and a coat layer covering the surface of the carrier core. The coat layers contain a coating resin (e.g., a fluororesin or a silicone resin), for example. A carrier (silicone resin carrier) containing the silicone resin out of these resins as a coating resin has highly durable coat layers and is difficult for other components (e.g., an external additive contained in the toner) to attach to the surfaces of the carrier particles thereof. Therefore, use of the silicone resin carrier as the carrier of a two-component developer can impart charge stability and fluidity to the toner to some extent. As the two-component developer containing the silicone resin carrier, a two-component developer is proposed for example that contains a silicone resin carrier and a non-magnetic toner containing non-magnetic pigment resin particles and resin fine particles.

### SUMMARY

A two-component developer according to a first embodiment of the present disclosure contains a carrier containing carrier particles and a toner containing toner particles. The carrier particles each include a carrier core and a coat layer covering a surface of the carrier core. The coat layers contain a silicone resin. The toner particles each include a toner mother particle and an external additive attached to a surface of the toner mother particle. The external additive contains specific resin particles. The specific resin particles contain a crosslinked resin. The specific resin particles have a number average primary particle diameter of at least 37 nm and no greater than 103 nm. The specific resin particles have a content of at least 0.6 parts by mass and no greater than 1.0 part by mass relative to 100 parts by mass of the toner mother particles.

A two-component developer according to a second embodiment of the present disclosure contains a carrier containing carrier particles and a toner containing toner particles. The carrier particles each include a carrier core and a coat layer covering a surface of the carrier core. The coat layers contain a silicone resin. The toner particles each include a toner mother particle and an external additive attached to a surface of the toner mother particle. The external additive contains specific resin particles. The specific resin particles contain a crosslinked resin. The specific resin particles have a number average primary particle diameter of at least 37 nm and no greater than 103 nm. The specific resin particles have a content of at least 0.6 parts by mass and no greater than 1.0 part by mass relative to 100 parts by mass of the toner mother particles. The carrier particles each further include contaminated resin particles attached to a surface of the coat layer. The contaminated resin particles have a percentage content of at least 0.005% by mass and no greater than 0.100% by mass in the carrier particles.

### BRIEF DESCRIPTION OF THE DRAWINGS

FIG. 1 is a diagram illustrating an example of a carrier particle.

FIG. 2 is a diagram illustrating an example of a toner particle.

### DETAILED DESCRIPTION

The following describes preferred embodiments of the present disclosure. Note that a toner is a collection (e.g., a powder) of toner particles. An external additive is a collection (e.g., a powder) of external additive particles. A carrier is a collection (e.g., a powder) of carrier particles. Unless otherwise stated, evaluation results (specific examples include values indicating shape or physical properties) for a powder (specific examples include a powder of toner particles, a powder of external additive particles, and a powder of carrier particles) are number averages of values as measured for a suitable number of particles selected from the powder.

The measurement values for volume median diameter (D₅₀) of powders are median diameters of the powders as measured using a laser diffraction/scattering type particle size distribution analyzer (“LA-950”, product of HORIBA, Ltd.) unless otherwise stated.

Unless otherwise stated, the number average particle diameter of a powder is a number average value of equivalent circle diameters (Heywood diameters: diameters of circles having the same areas as projected areas of the primary particles) of primary particles of the powder as measured using a scanning electron microscope. The number average primary particle diameter of a powder is a number average value of equivalent circle diameters of 100 primary particles of the powder, for example. Note that the number average primary particle diameter of particles refers to a number average primary particle diameter of the particles of a powder unless otherwise stated.

Chargeability refers to chargeability in triboelectric charging unless otherwise stated. For example, a measurement target (e.g., a toner) is triboelectrically charged by mixing and stirring the measurement target with a standard carrier (standard carrier for use with negatively chargeable toner: N-01, standard carrier for use with positively chargeable toner: P-01) provided by The Imaging Society of Japan. The amount of charge of the measurement target is measured using for example a compact suction-type charge measuring device (“MODEL 212HS”, product of TREK, INC.) before and after triboelectric charging. A larger change in amount of charge between before and after triboelectric charging indicates stronger chargeability of the measurement target.

The “main component” of a material means a component most abundant in the material in terms of mass unless otherwise stated.

The softening point (Tm) refers to a value as measured using a capillary rheometer (“CFT-500D”, product of Shimadzu Corporation) unless otherwise stated. On an S-shaped curve (vertical axis: temperature, horizontal axis: stroke) plotted using the capillary rheometer, the softening point (Tm) corresponds to a temperature corresponding to a stroke value of “(base line stroke value+maximum stroke value)/2”.

The glass transition point (Tg) refers to a value as measured in accordance with “Japanese Industrial Standard (JIS) K7121-2012” using a differential scanning calorimeter (“DSC-6220”, product of Seiko Instruments Inc.) unless otherwise stated. The glass transition point (Tg) corresponds to the temperature of a point of inflection caused by glass transition (in detail, the temperature at an intersection point of an extrapolated falling line and an extrapolated baseline) on a heat absorption curve (vertical axis: heat flow (DSC signal), horizontal axis: temperature) plotted using the differential scanning calorimeter.

The measurement values for acid value and hydroxyl value are values as measured in accordance with “Japanese Industrial Standard (JIS) K0070-1992” unless otherwise stated.

In the following description, the term “-based” may be appended to the name of a chemical compound to form a generic name encompassing both the chemical compound itself and derivatives thereof. When the term “-based” is appended to the name of a chemical compound used in the name of a polymer, the term indicates that a repeating unit of the polymer originates from the chemical compound or a derivative thereof. The term “(meth)acryl” may be used as a generic term for both acryl and methacryl. One type of each component described in the present specification may be used independently, or two or more types of the component may be used in combination.

### First Embodiment: Two-Component Developer

A two-component developer according to a first embodiment of the present disclosure contains a carrier containing carrier particles and a toner containing toner particles. The carrier particles each include a carrier core and a coat layer covering the surface of the carrier core. The coat layers contain a silicone resin. The toner particles each include a toner mother particle and an external additive attached to the surface of the toner mother particle. The external additive contains specific resin particles. The specific resin particles contain a crosslinked resin. The specific resin particles have a number average primary particle diameter of at least 37 nm and no greater than 103 nm. The specific resin particles have a content of at least 0.6 parts by mass and no greater than 1.0 part by mass relative to 100 parts by mass of the toner mother particles.

The two-component developer of the present disclosure can be used for image formation by electrophotographic apparatuses (image forming apparatuses), for example. When the carrier and the toner of the two-component developer of the present disclosure are stirred in a development device, the toner is charged.

The two-component developer of the present disclosure can be obtained by mixing while stirring the carrier and the toner using for example a mixer (specific examples include a ball mill and a ROCKING MIXER (registered Japanese trademark)). The toner has a percentage content (toner concentration) of preferably at least 1% by mass and no greater than 20% by mass in the two-component developer of the present disclosure, and more preferably at least 3% by mass and no greater than 15% by mass.

As a result of having the above features, the two-component developer of the present disclosure can exhibit excellent charge stability. The reason for this is inferred as follows. A known two-component developer containing a silicone resin carrier can exhibit some charge stability in normal consecutive printing owing to the carrier particles thereof having surfaces with poor attachability. However, due to the carrier particles thereof having surfaces with poor attachability, the amount of charge of the toner in the known two-component developer is likely to reduce under a printing condition susceptible to external stress, such as consecutive printing at low printing rate.

By contrast, the two-component developer of the present disclosure, which contains an optimized external additive, can stably maintain the amount of charge of the toner even under the printing conditions susceptible to external stress. Specifically, the toner of the two-component developer of the present disclosure contains an appropriate amount of the specific resin particles as the external additive. The specific resin particles contain a crosslinked resin to exhibit appropriate rigidity. The specific resin particles, which have an appropriate particle diameter, are hardly detached from the toner mother particles and are hardly buried in the toner mother particles. As a result, the specific resin particles function as excellent spacer particles to inhibit the toner from being affected by external stress. Thus, the two-component developer of the present disclosure can exhibit excellent toner charge stability and stably maintain the amount of charge of the toner even under the printing conditions susceptible to external stress.

### [Carrier Particles]

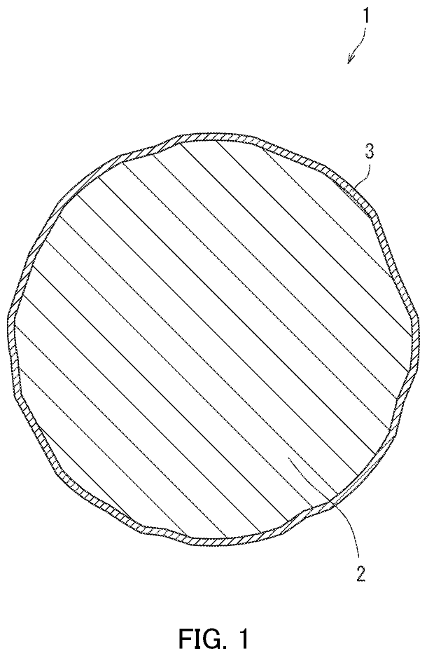

With reference to an accompanying drawing, an example of the carrier particles contained in the carrier is described below. FIG. 1 is a diagram illustrating a carrier particle 1 which is an example of the carrier particles. The carrier particle 1 includes a carrier core 2 and a coat layer 3 covering the surface of the carrier core 2. The coat layer 3 contains a silicone resin. The coat layer 3 covers the entire surface of the carrier core 2.

The carrier particle 1 has been described so far with reference to FIG. 1. However, the carrier particles contained in the carrier are not limited to the carrier particle 1 illustrated in FIG. 1. For example, the coat layer only needs to cover at least a part of the carrier core. In other words, a part of the carrier core may be exposed. Furthermore, the coat layers may have a multi-layer structure. Details of the elements of the carrier particles are described below.

### (Carrier Cores)

The carrier cores preferably contain a magnetic material. The carrier cores may be particles of a magnetic material or particles (also referred to below as resin carrier cores) containing a binder resin and particles of a magnetic material dispersed in the binder resin.

Examples of the magnetic material contained in the carrier cores include ferromagnetic metals (specific examples include iron, cobalt, nickel, and alloys containing at least one of these), and oxides of ferromagnetic metals. Examples of the oxides of ferromagnetic metals include ferrites and magnetite that is one type of spinel ferrite. Examples of the ferrites include Ba ferrite, Mn ferrite, Mn—Zn ferrite, Ni—Zn ferrite, Mn—Mg ferrite, Ca—Mg ferrite, Li ferrite, Cu—Zn ferrite, and Mn—Mg—Sr ferrite. An example of a method for producing the carrier cores is a method including pulverizing and baking the magnetic material. In production of the carrier cores, change in amount of the magnetic material added (particularly, a proportion of a ferromagnetic material) can adjust the saturation magnetization of the carrier. In addition, change in baking temperature in production of the carrier cores can adjust the roundness of the carrier cores. The carrier cores can be a commercially available product.

The particles of the magnetic material used as the carrier cores may be ferrite particles, for example. The ferrite particles tend to have magnetic properties sufficient for image formation using a two-component developer. Note that the ferrite particles produced by a typical production method are not perfectly spherical and tend to have moderate surface irregularities. When the carrier cores are ferrite particles (ferrite cores), the arithmetic mean roughness (specifically, the arithmetic mean roughness Ra defined by Japanese Industrial Standards (JIS) B0601-2013) of the surfaces of the ferrite cores is preferably at least 0.3 μm and no greater than 2.0 μm in terms of increasing adhesion between the coat layers and the surfaces of the ferrite cores.

The binder resin in the resin carrier cores is preferably a polyester resin, a urethane resin, or a phenolic resin, and more preferably a phenolic resin. The particles of the magnetic material in the resin carrier cores may be particles containing at least one of the magnetic materials listed above, for example.

The mass ratio of the carrier cores to the total mass of the carrier cores and the coat layers is preferably at least 70% by mass and no greater than 99% by mass in the carrier particles, and more preferably at least 90% by mass and no greater than 99% by mass.

Preferably, the carrier cores have a number average primary particle diameter of at least 20 μm and no greater than 60 μm. As a result of the number average primary particle diameter of the carrier cores being set to at least 20 μm, the two-component developer of the present embodiment can inhibit occurrence of carrier development. As a result of the number average primary particle diameter of the carrier cores being set to no greater than 60 μm, developability of the two-component developer of the present embodiment can be optimized.

Preferably, the carrier cores have a saturation magnetization in an applied magnetic field of 3000 Oe of at least 65 emu/g and no greater than 90 emu/g. As a result of the saturation magnetization of the carrier cores being set to at least 65 emu/g, the two-component developer of the present embodiment can inhibit occurrence of carrier development. As a result of the saturation magnetization of the carrier cores being set to no greater than 90 emu/g, developability of the two-component developer of the present disclosure can be optimized.

### (Coat Layers)

The coat layers contain a silicone resin. Preferably, the coat layers further contain metal oxide particles or carbon black particles. The coat layers have a thickness of at least 0.3 μm and no greater than 2.0 μm, for example.

The mass of the coat layers is preferably at least 0.5 parts by mass and no greater than 10.0 parts by mass relative to 100 parts by mass of the carrier cores, and more preferably at least 1.0 part by mass and no greater than 3.0 parts by mass. As a result of the mass of the coat layers being set to at least 0.5 parts by mass, the carrier cores can be inhibited from being exposed. As a result of the mass of the coat layers being set to no greater than 5.0 parts by mass, the carrier can easily charge the toner.

### (Silicone Resin)

The silicone resin is a resin having a polysiloxane structure (e.g., alkyl polysiloxane structure). Examples of the silicone resin include silicone resins with a methyl group and epoxy resin modified silicone resins. Examples of the silicone resins with a methyl group include a silicone resin with a methyl group and no phenyl group and a silicone resin with a methyl group and a phenyl group (also referred to below as a “methylphenyl silicone resin”). The silicone resin is preferably a methylphenyl silicone resin.

Preferably, the coat layers contain only the silicone resin as a resin. The percentage content of the silicone resin is preferably at least 90% by mass to the total of resins contained in the coat layers, and more preferably 100% by mass.

The silicone resin has a content of preferably at least 0.3 parts by mass and no greater than 8.0 parts by mass in the coat layers, more preferably at least 0.5 parts by mass and no greater than 4.0 parts by mass, and further preferably at least 1.0 part by mass and no greater than 2.0 parts by mass. As a result of the content of the silicone resin being set to at least 0.3 parts by mass, the metal oxide particles can be inhibited from being detached from the coat layers. As a result of the content of the silicone resin being set to no greater than 8.0 parts by mass, the two-component developer of the present disclosure can inhibit occurrence of fogging.

### (Metal Oxide Particles)

The metal oxide particles are preferably metal oxide particles (e.g., strontium titanate particles or barium titanate particles) which is ferroelectric, and more preferably barium titanate particles. As a result of the coat layers containing metal oxide particles, the two-component developer of the present disclosure can easily impart a desired amount of charge to the toner.

The metal oxide particles have a number average primary particle diameter of preferably at least 100 nm and no greater than 500 nm, and more preferably at least 250 nm and no greater than 350 nm. As a result of the number average primary particle diameter of the metal oxide particles being set to at least 100 nm, the two-component developer of the present disclosure can further easily impart a desired amount of charge to the toner. As a result of the number average primary particle diameter of the metal oxide particles being set to no greater than 500 nm, the metal oxide particles can be inhibited from being detached from the coat layers.

The metal oxide particles have a content of preferably at least 5 parts by mass and no greater than 80 parts by mass relative to 100 parts by mass of the silicone resin in the coat layers, and more preferably at least 20 parts by mass and no greater than 40 parts by mass. As a result of the content of the metal oxide particles being set to at least 5 parts by mass, the two-component developer of the present disclosure can further easily impart a desired amount of charge to the toner. As a result of the content of the metal oxide particles being set to no greater than 80 parts by mass, the metal oxide particles can be inhibited from being detached from the coat layers.

### (Carbon Black Particles)

The carbon black particles increase mobility of charge in the coat layers. As a result, the two-component developer of the present disclosure can easily impart a desired amount of charge to the toner.

The carbon black particles have a number average primary particle diameter of preferably at least 10 nm and no greater than 200 nm, and more preferably at least 20 nm and no greater than 60 nm. As a result of the number average primary particle diameter of the carbon black particles being set to at least 10 nm, the two-component developer of the present disclosure can further easily impart a desired amount of charge to the toner. As a result of the number average primary particle diameter of the carbon black particles being set to no greater than 200 nm, the carbon black particles can be inhibited from being detached from the coat layers.

The carbon black particles have a content of preferably at least 1 part by mass and no greater than 20 parts by mass relative to 100 parts by mass of the silicone resin in the coat layers, and more preferably at least 3 parts by mass and no greater than 8 parts by mass. As a result of the content of the carbon black particles being set to at least 1 part by mass, the two-component developer of the present disclosure can further easily impart a desired amount of charge to the toner. As a result of the content of the carbon black particles being set to no greater than 20 parts by mass, the carbon black particles can be inhibited from being detached from the coat layers.

### (Optional Component)

The coat layers may further contain any optional components other than the silicone resin, the metal oxide particles, and the carbon black particles. Examples of the optional components include a charge control agent, an adhesion improver, and a crosslinking agent.

### (Carrier Production Method)

The following describes an example of a carrier production method. The carrier production method includes an application process of applying a coating liquid onto the surfaces of the carrier cores and a heating process of heating the carrier cores after the application process.

### (Application Process)

In the present process, a coating liquid is applied onto the surfaces of the carrier cores. The coating liquid contains the silicone resin and a solvent. The coating liquid may further contain the metal oxide particles or the carbon black particles. The silicone resin may be a thermosetting silicone resin. The solid content concentration of the coating liquid is preferably at least 10% by mass and no greater than 30% by mass.

Examples of the solvent of the coating liquid include lactam compounds (e.g., 2-pyrrolidone and N-methyl-2-pyrrolidone), ketone compounds (e.g., methyl ethyl ketone and methyl isobutyl ketone), cyclic ether compounds (e.g., tetrahydrofuran and tetrahydropyran), alcohol compounds (e.g., normal butanol and isobutanol), ester solvents (e.g., ethyl acetate and isobutyl acetate), and aromatic hydrocarbon compounds (e.g., toluene and xylene). Toluene is preferable as the solvent of the coating liquid.

Examples of a method for applying the coating liquid onto the surfaces of the carrier cores include immersion of the carrier cores in the coating liquid and spraying of the coating liquid onto the carrier cores in a fluidized bed. In the immersion of the carrier cores in the coating liquid, a large amount of the coating liquid is applied onto the recesses on the surfaces of the carrier cores while a small amount of the coating liquid is applied onto the projections on the surfaces of the carrier cores, resulting in non-uniform application of the coating liquid. By contrast, the spraying of the coating liquid onto the carrier cores in a fluidized bed tends to apply the coating liquid evenly to both the projections and recesses on the surfaces of the carrier cores. In view of the above, the spraying of the coating liquid onto the carrier cores in a fluidized bed is the preferred method for applying the coating liquid onto the surfaces of the carrier cores.

### (Heating Process)

In the present process, the carrier cores after the application process are heated to remove the solvent contained in the coating liquid. When uncured silicone resin is contained in the coating liquid, the uncured silicone resin is heat-cured. As a result, the coat layers are formed from the coating liquid. Examples of the heating conditions include a heating temperature of at least 150° C. and no greater than 300° C. and a heating time of at least 30 minutes and no greater than 90 minutes.

### [Toner]

The toner contains toner particles. The toner particles each include a toner mother particle and an external additive attached to the surface of the toner mother particle. Details of the toner are described below with reference to an accompanying drawing as appropriate.

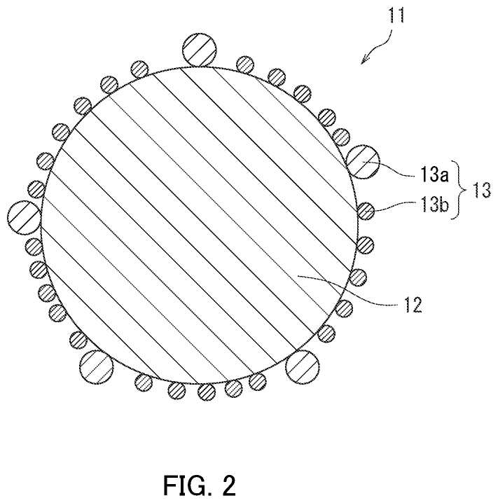

FIG. 2 illustrates an example of a toner particle 11 contained in the toner. The toner particle 11 illustrated in FIG. 2 includes a toner mother particle 12 and an external additive 13 attached to the surface of the toner mother particle 12. The external additive 13 contains specific resin particles 13a and silica particles 13b.

The toner particles have been described so far with reference to the drawing. However, the toner particles may have a structure different from that of the toner particle 11 illustrated in FIG. 2. Specifically, the external additive may contain only the specific resin particles. Alternatively, the external additive may contain additional external additive particles besides the specific resin particles and the silica particles. The toner mother particles may each be a capsule toner particle including a toner core and a shell layer covering the toner core.

### (External Additive)

The external additive is attached to the surfaces of the toner mother particles. The external additive contains specific resin particles. Preferably, the external additive further contains silica particles.

### (Specific Resin Particles)

The specific resin particles contain a crosslinked resin. Examples of the crosslinked resin include crosslinked polyester resins, crosslinked styrene resins, crosslinked (meth)acrylic resins, crosslinked styrene-(meth)acrylic resins, crosslinked olefin resins (e.g., crosslinked polyethylene resin and crosslinked polypropylene resin), crosslinked vinyl chloride resins, crosslinked polyvinyl alcohols, crosslinked vinyl ether resins, crosslinked N-vinyl resins, crosslinked polyamide resins, and crosslinked urethane resins.

The crosslinked resin is preferably a crosslinked styrene-(meth)acrylic resin including a first repeating unit (styrene unit) derived from a styrene compound and a second repeating unit ((meth)acrylic acid unit) derived from a (meth)acrylic acid compound. Preferably, the crosslinked styrene-(meth)acrylic resin further include a third repeating unit derived from a crosslinking agent. The total percentage content of the first to third repeating units in all repeating units included in the crosslinked resin is preferably at least 90% by mol, more preferably at least 99% by mol, and further preferably 100% by mol.

Examples of the styrene compound include styrene, α-methylstyrene, p-hydroxystyrene, m-hydroxystyrene, vinyltoluene, α-chlorostyrene, o-chlorostyrene, m-chlorostyrene, p-chlorostyrene, and p-ethylstyrene. Styrene is preferable as the styrene compound.

Examples of the (meth)acrylic acid compound include (meth)acrylic acid, (meth)acrylonitrile, (meth)acrylic acid alkyl esters, and (meth)acrylic acid hydroxyalkyl esters.

An example of the (meth)acrylic acid alkyl esters is (meth)acrylic acid alkyl ester with an alkyl group having a carbon number of at least 1 and no greater than 8. Specific examples of the (meth)acrylic acid alkyl esters include methyl (meth)acrylate, ethyl (meth)acrylate, n-propyl (meth)acrylate, iso-propyl (meth)acrylate, n-butyl (meth)acrylate, iso-butyl (meth)acrylate, and 2-ethylhexyl (meth)acrylate.

Examples of the (meth)acrylic acid hydroxyalkyl esters include 2-hydroxyethyl (meth)acrylate, 3-hydroxypropyl (meth)acrylate, 2-hydroxypropyl (meth)acrylate, and 4-hydroxybutyl (meth)acrylate.

As the (meth)acrylic acid compound, a (meth)acrylic acid alkyl ester is preferable, and methyl (meth)acrylate is more preferable.

The percentage content of the styrene unit is preferably at least 29% by mol and no greater than 61% by mol to 100% by mol of the total of the styrene unit and the (meth)acrylic acid unit in the crosslinked resin, and more preferably at least 29% by mol and no greater than 40% by mol. A crosslinked resin with a higher percentage content of the styrene unit tends to have a lower affinity for the binder resin contained in the toner mother particles. Therefore, the affinity between the specific resin particles and the toner mother particles can be moderately reduced by setting the percentage content of the styrene unit to at least 29% by mol. As a result, burial of the specific resin particles in the toner mother particles can be effectively inhibited. By setting the percentage content of the styrene unit to no greater than 61% by mol by contrast, excessive reduction in affinity between the specific resin particles and the toner mother particles can be suppressed. As a result, detachment of the specific resin particles from the toner mother particles can be effectively inhibited.

An example of the crosslinking agent is a compound with two or more vinyl groups. Specific examples of the crosslinking agent include N,N′-methylene bisacrylamide, divinylbenzene, ethylene glycol diacrylate, ethylene glycol dimethacrylate, diethylene glycol diacrylate, tetraethylene glycol diacrylate, polyethylene glycol diacrylate, 1,4-butanediol diacrylate, 1,6-hexanediol diacrylate, tripropylene glycol diacrylate, trimethylolpropane triacrylate, pentaerythritol triacrylate, pentaerythritol tetraacrylate, 1,4-butanediol dimethacrylate, and 1,6-hexanediol dimethacrylate. Ethylene glycol dimethacrylate is preferable as the crosslinking agent.

The percentage content of the third repeating unit derived from the crosslinking agent is preferably at least 0.5% mol and no greater than 5.0% by mol to 100% by mol of the total of the styrene unit and the (meth)acrylic acid unit in the crosslinked resin, and more preferably at least 1.5% by mol and no greater than 4.0% by mol. As a result of the percentage content of the third repeating unit being set to at least 0.5% by mol and no greater than 5.0% by mol, moderate rigidity can be imparted to the specific resin particles.

The crosslinked resin is preferably a copolymer of styrene, methyl methacrylate, and ethylene glycol dimethacrylate.

The specific resin particles have a number average primary particle diameter of at least 37 nm and no greater than 103 nm, and preferably at least 37 nm and no greater than 60 nm. As a result of the number average primary particle diameter of the specific resin particles being set to at least 37 nm, burial of the specific resin particles in the toner mother particles can be inhibited. As a result of the number average primary particle diameter of the specific resin particles being set to no greater than 103 nm by contrast, detachment of the specific resin particles from the toner mother particles can be inhibited.

In terms of sufficiently exhibiting the function of the specific resin particles while inhibiting detachment thereof from the toner mother particles, the content of the specific resin particles is preferably at least 0.6 parts by mass and no greater than 1.0 part by mass relative to 100 parts by mass of the toner mother particles in the toner particles, and more preferably at least 0.6 parts by mass and no greater than 0.8 parts by mass. As a result of the content of the specific resin particles being set to at least 0.6 parts by mass, the two-component developer of the present disclosure can exhibit excellent toner charge stability. As a result of the content of the specific resin particles being set to no greater than 1.0 part by mass, detachment of the specific resin particles from the toner mother particles can be inhibited.

The specific resin particles can be produced by emulsion polymerization of monomers (e.g., a styrene compound, a (meth)acrylic acid compound, and a crosslinking agent) being raw materials in presence of an ionic surfactant (emulsifier), for example. Benzoyl peroxide can be used as a polymerization initiator used for emulsion polymerization, for example. The amount of the surfactant used is at least 2 parts by mass and no greater than 10 parts by mass relative to 100 parts by mass of the monomers being the raw materials, for example.

### (Ionic Surfactant)

Preferably, the toner particles each further include an ionic surfactant attached to the surfaces of the specific resin particles. The ionic surfactant derives from the ionic surfactant used in production of the specific resin particles as described above. The ionic surfactant adjusts chargeability of the toner particles. Examples of the ionic surfactant include cationic surfactants and anionic surfactants. The ionic surfactant is preferably a cationic surfactant.

An example of the cationic surfactants is an alkyl trimethyl ammonium salt with an alkyl group having a carbon number of at least 10 and no greater than 25. A specific example of the cationic surfactants is a cetyltrimethylammonium salt, and more preferable example thereof is cetyltrimethylammonium chloride.

An example of the anionic surfactants is an alkyl benzene sulfonate with an alkyl group having a carbon number of at least 10 and no greater than 25. A specific example of the anionic surfactants is a dodecylbenzene sulfonate, and more preferable example thereof is sodium dodecylbenzenesulfonate.

### (Silica Particles)

The silica particles are preferably silica particles that have undergone a surface treatment for imparting hydrophobicity. The silica particles have a number average primary particle diameter of preferably at least 20 nm and no greater than 100 nm, and more preferably at least 20 nm and no greater than 35 nm. As a result of the number average primary particle diameter of the silica particles being set to at least 20 nm, burial of the silica particles in the toner mother particles can be inhibited. As a result of the number average primary particle diameter of the silica particles being set to no greater than 100 nm, detachment of the silica particles from the toner mother particles can be inhibited.

In terms of sufficiently exhibiting the function of the silica particles while inhibiting detachment thereof from the toner mother particles, the content of the silica particles is preferably at least 0.1 parts by mass and no greater than 15.0 parts by mass relative to 100 parts by mass of the toner mother particles in the toner particles, and more preferably at least 0.5 parts by mass and no greater than 3.0 parts by mass.

### (Toner Mother Particles)

The toner mother particles contain at least one selected from the group consisting of a binder resin, a colorant, a charge control agent, and a releasing agent, for example. The following describes the binder resin, the colorant, the charge control agent, and the releasing agent.

### (Binder Resin)

In order that the toner have excellent low-temperature fixability, the toner mother particles preferably contain a thermoplastic resin as a binder resin, and further preferably contain the thermoplastic resin in a proportion of at least 85% by mass of the total mass of binder resins. Examples of the thermoplastic resin include polyester resins, styrene-based resins, acrylic acid ester-based resins (specific examples include acrylic acid ester polymers and methacrylic acid ester polymers), olefin-based resins (specific examples include polyethylene resin and polypropylene resin), vinyl resins (specific examples include vinyl chloride resin, polyvinyl alcohol, vinyl ether resin, and N-vinyl resin), polyamide resins, and urethane resins. Alternatively, a copolymer of any of these, that is, a copolymer (specific examples include styrene-acrylic resin and styrene-butadiene-based resin) with any repeating unit introduced in any of the above-listed resins may be used as a binder resin.

The binder resin is preferably a polyester resin. The polyester resin is a polymer of at least one polyhydric alcohol monomer and at least one polybasic carboxylic acid monomer. Note that a polybasic carboxylic acid derivative (specific examples include anhydrides of polybasic carboxylic acids and halides of polybasic carboxylic acids) may be used instead of the polybasic carboxylic acid monomer.

Examples of the polyhydric alcohol monomer include diol monomers, bisphenol monomers, and tri- or higher-hydric alcohol monomers.

Examples of the diol monomers include ethylene glycol, diethylene glycol, triethylene glycol, 1,2-propanediol, 1,3-propanediol, 1,4-butanediol, neopentyl glycol, 2-butene-1,4-diol, 1,5-pentanediol, 1,6-hexanediol, 1,4-cyclohexanedimethanol, 1,4-benzenediol, dipropylene glycol, polyethylene glycol, polypropylene glycol, and polytetramethylene glycol.

Examples of the bisphenol monomers include bisphenol A, hydrogenated bisphenol A, bisphenol A ethylene oxide adduct, and bisphenol A propylene oxide adduct.

Examples of the tri- or higher hydric alcohol monomers include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Examples of the polybasic carboxylic acid monomer include dibasic carboxylic acid monomers and tri- or higher-basic carboxylic acid monomers.

Examples of the dibasic carboxylic acid monomers include maleic acid, fumaric acid, citraconic acid, itaconic acid, glutaconic acid, phthalic acid, isophthalic acid, terephthalic acid, 5-sulfoisophthalic acid, sodium 5-sulfoisophthalate, cyclohexanedicarboxylic acid, adipic acid, sebacic acid, azelaic acid, malonic acid, succinic acid, alkyl succinic acids, and alkenyl succinic acids. Examples of the alkyl succinic acids include n-butylsuccinic acid, isobutylsuccinic acid, n-octylsuccinic acid, n-dodecylsuccinic acid, and isododecylsuccinic acid. Examples of the alkenyl succinic acids include n-butenylsuccinic acid, isobutenylsuccinic acid, n-octenylsuccinic acid, n-dodecenylsuccinic acid, and isododecenylsuccinic acid.

Examples of the tri- or higher-basic carboxylic acid monomers include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, and EMPOL trimer acid.

The polyester resin is preferably a polymer of a bisphenol monomer, a dibasic carboxylic acid monomer, and a tribasic carboxylic monomer, more preferably a polymer of bisphenol A alkylene oxide adduct, a dicarboxylic acid having a carbon number of at least 3 and no greater than 6, and aryltricarboxylic acid, and further preferably a polymer of bisphenol A ethylene oxide adduct, bisphenol A propylene oxide adduct, fumaric acid, and trimellitic acid.

The polyester resin is preferably non-crystalline polyester resin. It is often not possible to clearly measure the melting point of a non-crystalline polyester resin. Therefore, a polyester resin whose endothermic peak cannot be clearly determined in an endothermic curve plotted using a differential scanning calorimeter can be determined to be a non-crystalline polyester resin.

The softening point of the polyester resin is preferably at least 50° C. and no greater than 200° C., and more preferably at least 80° C. and no greater than 120° C. The glass transition point of the polyester resin is preferably at least 30° C. and no greater than 80° C., and more preferably at least 45° C. and no greater than 55° C.

The mass average molecular weight of the polyester resin is preferably at least 10,000 and no greater than 50,000, and more preferably at least 20,000 and no greater than 40,000.

The acid value of the polyester resin is preferably at least 20 mgKOH/g and no greater than 70 mgKOH/g, and more preferably at least 30 mgKOH/g and no greater than 50 mgKOH/g. The hydroxyl value of the polyester resin is preferably at least 1 mgKOH/g and no greater than 50 mgKOH/g, and more preferably at least 15 mgKOH/g and no greater than 25 mgKOH/g.

### (Colorant)

The colorant can be a known pigment or dye that matches the color of the toner. Examples of the colorant include black colorants, yellow colorants, magenta colorants, and cyan colorants.

Carbon black can be used as a black colorant, for example. Alternatively, a colorant can be used that has been adjusted to a black color using colorants such as a yellow colorant, a magenta colorant, and a cyan colorant.

The content of the colorant is preferably at least 1 part by mass and no greater than 20 parts by mass relative to 100 parts by mass of the binder resin in the toner.

### (Charge Control Agent)

The charge control agent is used for example for the purpose of improving charge stability and a charge rise characteristic of the toner. The charge rise characteristic of the toner is an indicator as to whether the toner can be charged to a specific charge level in a short period of time. Examples of the charge control agent include positively chargeable charge control agents and negatively chargeable charge control agents. Cationicity (positive chargeability) of the toner can be increased by the toner mother particles containing a positively chargeable charge control agent. Anionicity (negative chargeability) of the toner can be increased by the toner mother particles containing a negatively chargeable charge control agent. Examples of the positively chargeable charge control agents include pyridine, nigrosine, and quaternary ammonium salt. Examples of the negatively chargeable charge control agents include metal-containing azo dyes, sulfo group-containing resins, oil-soluble dyes, naphthenic acid metal salts, acetylacetone metal complexes, salicylic acid-based metal complexes, boron compounds, fatty acid soaps, and long-chain alkyl carboxylates. When sufficient chargeability of the toner is ensured, the toner mother particles need not contain any charge control agent. The content of the charge control agent is preferably at least 1 part by mass and no greater than 10 parts by mass relative to 100 parts by mass of the binder resin in the toner mother particles.

### (Releasing Agent)

The releasing agent is used for example for the purpose of increasing hot offset resistance of the toner. Examples of the releasing agent include aliphatic hydrocarbon-based waxes, oxides of aliphatic hydrocarbon-based waxes, plant waxes, animal waxes, mineral waxes, ester waxes having a fatty acid ester as a main component, and waxes in which a fatty acid ester has been partially or fully deoxidized. Examples of the aliphatic hydrocarbon-based waxes include polyethylene waxes (e.g., low molecular weight polyethylene), polypropylene waxes (e.g., low molecular weight polypropylene), polyolefin copolymers, polyolefin wax, microcrystalline wax, paraffin wax, and Fischer-Tropsch wax. Examples of the oxides of aliphatic hydrocarbon waxes include oxidized polyethylene waxes and block copolymers of oxidized polyethylene waxes. Examples of the plant waxes include candelilla wax, carnauba wax, Japan wax, jojoba wax, and rice wax. Examples of the animal waxes include beeswax, lanolin, and spermaceti. Examples of the mineral waxes include ozokerite, ceresin, and petrolatum. Examples of the waxes having a fatty acid ester as a main component include montanic acid ester wax and castor wax. Examples of the waxes in which a fatty acid ester has been partially or fully deoxidized include deoxidized carnauba wax. The content of the releasing agent is preferably at least 1 part by mass and no greater than 20 parts by mass relative to 100 parts by mass of the binder resin in the toner mother particles.

Note that the toner particles may contain a known additive as necessary. Preferably, the toner particles have a volume median diameter of at least 4 μm and no greater than 12 μm. The toner mother particles have a volume median diameter of preferably at least 4 μm and no greater than 12 μm, and more preferably at least 5 μm and no greater than 9 μm. The toner particles can be a magnetic toner or a non-magnetic toner. When the toner particles are a magnetic toner, the toner mother particles further contain a magnetic powder.

### (Toner Production Method)

The following describes an example of a method for producing the toner. The method for producing the toner includes a toner mother particle preparation process of preparing the toner mother particles and an external additive addition process of adding the external additive to the surfaces of the toner mother particles. The external additive contains the specific resin particles.

### (Toner Mother Particle Preparation Process)

In the toner mother particle preparation process, the toner mother particles are prepared by the pulverization method or the aggregation method. In the toner mother particle preparation process, the toner mother particles are preferably prepared by the pulverization method. That is, it is preferable that the toner mother particles in the toner are pulverized toner mother particles.

In one example of the pulverization method, the binder resin and any of the optional components added as necessary are mixed first. Subsequently, the resulting mixture is melt-kneaded using a melt-kneading apparatus (e.g., a single- or twin-screw extruder). Subsequently, the resulting melt-kneaded product is pulverized and classified. Thus, the toner mother particles are obtained.

In one example of the aggregation method, fine particles of the binder resin and fine particles of any of the optional components added as necessary are aggregated in an aqueous medium containing these fine particles until the resultant aggregate particles have a desired particle diameter. Thus, aggregated particles containing the binder resin and the like are formed. Subsequently, the resulting aggregated particles are heated to cause the components contained in the aggregated particles to coalesce. Thus, the toner mother particles are obtained.

### (External Additive Addition Process)

In the present process, the external additive is attached to the surfaces of the toner mother particles. An example of a method for attaching the external additive (external additive particles) to the surfaces of the toner mother particles is mixing while stirring the toner mother particles and external additive particles using a mixer.

### Second Embodiment: Two-Component Developer

A two-component developer according to a second embodiment of the present disclosure contains a carrier containing carrier particles and a toner containing toner particles. The carrier particles each include a carrier core and a coat layer covering the surface of the carrier core. The coat layers contain a silicone resin. The toner particles each include a toner mother particle and an external additive attached to the surface of the toner mother particle. The external additive contains specific resin particles. The specific resin particles contain a crosslinked resin. The specific resin particles have a number average primary particle diameter of at least 37 nm and no greater than 103 nm. The specific resin particles have a content of at least 0.6 parts by mass and no greater than 1.0 part by mass relative to 100 parts by mass of the toner mother particles. The carrier particles each further include contaminated resin particles attached to the surface of the coat layer. The contaminated resin particles have a percentage content of at least 0.005% by mass and no greater than 0.100% by mass in the carrier particles.

The two-component developer according to the second embodiment of the present disclosure differs from the two-component developer according to the first embodiment in that the carrier particles each further include a certain amount of contaminated resin particles. The contaminated resin particles, which serve as the above-described difference, are described below.

### (Contaminated Resin Particles)

The contaminated resin particles derive from the specific resin particles that have been originally contained as the external additive of the toner. The contaminated resin particles are generated by the specific resin particles being detached from the toner mother particles and attached to the surfaces of the carrier particles during production, storage, or used of the two-component developer of the present disclosure. The contaminated resin particles reduce performance of the carrier. Therefore, the percentage content of the contaminated resin particles is preferably no greater than 0.100% by mass in the carrier particles. Examples of a method for reducing the percentage content of the contaminated resin particles include setting the number average primary particle diameter of the specific resin particles to no greater than a specific value (e.g., no greater than 103 nm), and setting the content of the specific resin particles to no greater than a specific value (e.g., no greater than 1.0 prat by mass relative to 100 parts by mass of the toner mother particles). According to any of the above methods, the specific resin particles are hardly detached from the toner mother particles to reduce the percentage content of the contaminated resin particles.

As described above, the contaminated resin particles are inherently undesirable components, but have little effect on performance of the carrier if the percentage content thereof is no greater than 0.100% by mass. In order to completely eliminate the contaminated resin particles, it is necessary to make the number average primary particle diameter of the specific resin particles excessively small or to excessively reduce the content of the specific resin particles. This may involve another adverse influence. From the above view point, presence of a small amount of the contaminated resin particles is acceptable in the two-component developer of the present disclosure. Specifically, the percentage content of the contaminated resin particles is at least 0.005% by mass and no greater than 0.100% by mass, for example. Note that the percentage content of the contaminated resin particles is measured by the method described in Examples or a method in accordance therewith.

### Examples

The following provides more specific description of the present disclosure through use of examples. However, the present disclosure is not limited to the scope of the examples.

In the present examples, the saturation magnetization and coercivity of carrier cores were measured in an applied magnetic field of 3000 Oe using a high sensitivity vibrating sample magnetometer (“VSM-P7”, product of Toei Industry Co., Ltd.).

Each number average primary particle diameter of specific resin particles, silica particles, barium titanate particles, carbon black particles, and carrier cores was measured using a scanning electron microscope (“JSM-7600F”, product of JEOL Ltd., field emission scanning electron microscope). In the number average primary particle diameter measurement, equivalent circle diameters (Heywood diameters: diameters of circles having the same areas as projected areas of the primary particles) of 100 primary particles were measured and a number average thereof was calculated.

### [Toner Mother Particle Preparation]

A 5-L four-necked flask equipped with a thermometer (thermocouple), a dewatering conduit, a nitrogen inlet tube, a rectification column, and a stirring device was set in an oil bath, and 1200 parts by mass of 1,2-propanediol, 1700 parts by mass of terephthalic acid, and 3 parts by mass of tin(II) dioctoate were charged into the flask. Subsequently, the flask contents were allowed to react (specifically, condensation reaction) at a temperature of 230° C. in a nitrogen atmosphere for 15 hours. Subsequently, the internal pressure of the flask was reduced and the flask contents were allowed to react at a temperature of 230° C. in the reduced pressure atmosphere (pressure 8.0 kPa) until the softening point of the reaction product (polyester resin) reached a specific temperature (100° C.). As a result, a polyester resin with a glass transition point of 48° C. and a softening point of 100° C. was yielded.

Using an FM mixer (“FM-10C/I”, product of Nippon Coke & Engineering Co., Ltd.), 100 parts by mass of the polyester resin yielded as above, 5 parts by mass of a colorant (C.I. Pigment Blue 15:3, component: copper phthalocyanine pigment), and 5 parts by mass of a releasing agent (“NISSAN ELECTOL (registered Japanese trademark) WEP-3”, product of NOF CORPORATION, ester wax with a melting point of 73° C.) were mixed (dry mixing) at a rotational speed of 2400 rpm.

Subsequently, the resulting mixture was melt-kneaded using a twin screw extruder (“PCM-30”, product of Ikegai Corp.). The resulting melt-kneaded product was subsequently cooled. Subsequently, the cooled melt-kneaded product was pulverized under a condition of a set particle diameter of 5.6 μm using a mechanical pulverizer (“TURBO MILL T250”, product of FREUND-TURBO CORPORATION). Next, the resulting pulverized product was classified using a classifier (“ELBOW JET MODEL EJ-LABO”, product of Nittetsu Mining Co., Ltd.). Thus, a powder of toner mother particles with a volume median diameter (D₅₀) of 6.0 μm was obtained. The obtained toner mother particles had a roundness of 0.931, a glass transition point of 50° C., a softening point pf 98° C., and a zeta potential of −20 mV at pH 4. The amount of triboelectric charge between the resulting toner mother particles and the standard carrier N-01 (standard carrier for negatively chargeable toner provided by The Imaging Society of Japan) was −20 μC/g. It was confirmed from the data on the zeta potentials and amounts of triboelectric charge that the toner mother particles were anionic (negatively chargeable).

### [Specific Resin Particle Preparation]

Specific resin particles (a) to (h) were prepared by the following methods.

### (Specific Resin Particles (a))

A 1-L four-necked flask equipped with a stirring device, a cooling tube, a thermometer, and a nitrogen inlet tube was used as a reaction vessel. Into the reaction vessel, 65 parts by mass of styrene, 145 parts by mass of methyl methacrylate, 10 parts by mass of ethylene glycol dimethacrylate, 26 parts by mass of a cationic surfactant (cetyltrimethylammonium chloride), 15 parts by mass of a polymerization initiator (benzoyl peroxide), and 600 parts by mass of ion exchange water were charged under stirring. A molar ratio (St:MMA:EGDMA) of the charged styrene (St), methyl methacrylate (MMA), and ethylene glycol dimethacrylate (EGDMA) was 12:28:1.

The contents of the reaction vessel were then stirred while nitrogen gas was introduced into the reaction vessel to place the interior of the reaction vessel in a nitrogen atmosphere. Furthermore, the temperature of the contents of the reaction vessel in the nitrogen atmosphere was increased to 90° C. while the contents of the reaction vessel were stirred. Thereafter, the contents of the reaction vessel were allowed to react (specifically, polymerization reaction) at a temperature of 90° C. under stirring in the nitrogen atmosphere for 3 hours to yield an emulsion containing a reaction product (specific resin particles (a)). Subsequently, the resulting emulsion was cooled, washed, and dehydrated. Through the above, a powder of specific resin particles (a) with a number average primary particle diameter of 40 nm was obtained. The specific resin particles (a) contained a crosslinked resin. The surfactant (cetyltrimethylammonium chloride) was attached to the surfaces of the specific resin particles (a).

### (Specific Resin Particles (b) to (h))

The specific resin particles (b) to (h) were prepared according to the same method as that for preparing the specific resin particles (a) in all aspects other than that the types and amounts of components used were changed to those as shown below in Table 1. In Table 1 below, “St rate” refers to the rate of styrene to 100% by mol of the total of styrene and methyl methacrylate. “Part” refers to part by mass. “Cationic” as a surfactant type indicates use of the cationic surfactant (cetyltrimethylammonium chloride). “Anionic” as the surfactant type indicates use of an anionic surfactant (sodium dodecylbenzenesulfonate). “Diameter” refers to the number average primary particle diameter. “Initiator” refers to the polymerization initiator used. “BPO” refers to benzoyl peroxide. “AP” refers to ammonium persulfate.

TABLE 1

| | Styrene | | MMA | | EDGM | | | | | | | |
|---|---|---|---|---|---|---|---|---|---|---|---|---|
| | Molar | | Molar | | Molar | | St rate | Surfactant | | Initiator | | Diameter |
| | ratio | Part | ratio | Part | ratio | Part | [% by mol] | Type | Part | Type | Part | [nm] |
| a | 12 | 65 | 28 | 145 | 1 | 10 | 30 | Cationic | 26 | BPO | 15 | 40 |
| b | 24 | 128 | 16 | 82 | 1 | 10 | 60 | Cationic | 14 | BPO | 15 | 100 |
| c | 24 | 128 | 16 | 82 | 1 | 10 | 60 | Anionic | 14 | AP | 15 | 100 |
| d | 11.2 | 60 | 28.8 | 149 | 1 | 10 | 28 | Cationic | 14 | BPO | 15 | 100 |
| e | 24.8 | 132 | 15.2 | 78 | 1 | 10 | 62 | Cationic | 26 | BPO | 15 | 40 |
| f | 24 | 128 | 16 | 82 | 1 | 10 | 60 | Cationic | 27 | BPO | 15 | 35 |
| g | 12 | 65 | 28 | 145 | 1 | 10 | 30 | Cationic | 13 | BPO | 15 | 105 |
| h | 12 | 65 | 28 | 145 | — | — | 30 | Cationic | 26 | BPO | 15 | 40 |

### [Toner Preparation]

Toners (A) to (L) were prepared by the following methods.

### (Toner (A))

Using a 5-L FM mixer (product of Nippon Coke & Engineering Co., Ltd.), 100.0 parts by mass of the toner mother particles and 0.6 parts by mass of the specific resin particles (a) were mixed for 10 minutes under conditions of a rotational speed of 3000 rpm and a jacket temperature of 20° C. Thus, first particles including the toner mother particles and the specific resin particles (a) attached to the surfaces of the toner mother particles were obtained.

Next, 100.0 parts by mass of the first particles and 0.4 parts by mass of positively chargeable silica particles were mixed for 30 seconds under conditions of a rotational speed of 3000 rpm and a jacket temperature of 20° C. using a 5-L FM mixer (product of Nippon Coke & Engineering Co., Ltd.) to obtain a mixture. Next, sifting was performed on the mixture using a 300-mesh sieve (opening 48 μm). Thus, a toner (A) containing the toner mother particles and an external additive (the specific resin particles (a) and the positively chargeable silica particles) attached to the surfaces of the toner mother particles was obtained.

Note that fumed silica particles (“AEROSIL (registered Japanese trademark) 90G”, product of NIPPON AEROSIL CO., LTD.) surface-treated with silicone oil and aminosilane were used as the positively chargeable silica particles.

### (Toners (B) to (L))

The toners (B) to (L) were prepared according to the same method as that for preparing the toner (A) in all aspects other than that the type and amount added of the specific resin particles used were changed to those shown below in Table 2.

### [Carrier Preparation]

A silicone resin carrier and a fluororesin carrier were prepared by the following methods. The silicone resin carrier contained a silicone resin in the coat layers thereof. The fluororesin carrier contained a fluororesin in the coat layers thereof.

### (Silicone Resin Carrier Preparation)

Into a stainless vessel, 1000 parts by mass of a silicone resin solution (“KR-255”, product of Shin-Etsu Chemical Co., Ltd., solid content: methylphenyl silicone resin, solid content concentration: 50% by mass, solid content amount: 500.0 parts by mass), 150 parts by mass of barium titanate particles (product of KCM Corporation, number average primary particle diameter: 300 nm), 30 parts by mass of a carbon black (“KETJEN BLACK EC 600JD”, product of LION SPECIALTY CHEMICALS CO., LTD., conductive carbon black, DBP oil absorption: 495 cm³/100 g, BET specific surface area: 1270 m²/g, number average primary particle diameter: 34.0 nm), and 1450 parts by mass of toluene were charged. The contents of the stainless vessel were mixed using a homogenizer to obtain a coating liquid (L1).

The coating liquid (L1) was sprayed on the carrier cores while 5000 g of the carrier cores were allowed to flow using a fluidized bed coating apparatus (“FD-MP-01 MODEL D”, product of Powrex Corporation). In the manner described above, carrier cores coated with the coating liquid (L1) were obtained. The coating conditions included a supply air temperature of 80° C., supply air flow rate of 0.3 m³/min, and a rotor rotational speed of 400 rpm. Next, the carrier cores coated with the coating liquid (L1) were heated at 250° C. for 2 hours using an oven. Thus, the silicone resin carrier was obtained.

The carrier cores used were manganese ferrite cores (product of DOWA IP CREATION CO., LTD., volume median diameter: 39 μm, saturation magnetization: 80 emu/g). In the carrier core coating, the supply amount of the coating liquid (L1) was set so that the mass of the coat layers formed on the silicone resin carrier was 110 g. In other words, the mass (110 g) of the coat layers relative to 100 parts by mass (5000 g) of the carrier cores was 2.2 parts by mass in the silicone resin carrier.

### [Fluororesin Carrier Preparation]

Appropriate amounts of raw materials (raw materials of MnO, MgO, Fe₂O₃, and SrO) were blended to give 39.7% by mol in terms of MnO, 9.9% by mol in terms of MgO, 49.6% by mol in terms of Fe₂O₃, and 0.8% by mol in terms of SrO, and water was added to the blended raw materials. Subsequently, the blended raw materials were mixed while being pulverized over 10 hours using a wet ball mill. Subsequently, the resulting mixture was dried. Subsequently, the dried mixture was heat-treated at a temperature of 950° C. for 4 hours. Subsequently, the heat-treated mixture was pulverized over 24 hours using a wet ball mill to prepare a slurry. Subsequently, drying and granulation were performed on the resulting slurry using a spray dryer. Subsequently, the dried granules were held in an atmosphere at a temperature of 1270° C. and an oxygen concentration of 2% for 6 hours, and then crushed.

Thereafter, particle size adjustment was performed to obtain a powder (number average primary particle diameter 35 μm) of Mn—Mg—Sr ferrite particles (magnetic carrier cores) with a saturation magnetization of 70 Am²/kg.

Subsequently, 20 parts by mass of a polyamide-imide resin (copolymer of trimellitic anhydride and 4,4′-diaminodiphenylmethane) was diluted with 918 parts by mass of methyl ethyl ketone to prepare a resin solution. Subsequently, 80 parts by mass of FEP particles were dispersed in the resin solution. Next, 2 parts by mass (2 parts by mass relative to 100 parts by mass of the total of resins) of silicon oxide was added to the resin solution. Thus, a coating liquid (L2) with a solid content concentration of 10% by mass was obtained. The mass ratio (FEP particles/polyamide-imide resin) of the FEP particles to the polyamide-imide resin was 2/8 in the coating liquid (L2).

Subsequently, 10 kg of the aforementioned magnetic carrier cores (Mn—Mg—Sr ferrite particles) were coated with 1500 g (150 g in terms of solid content) of the aforementioned coating liquid (L2) using a rolling fluidized bed coating apparatus (“SPIRA COTA (registered Japanese trademark) SP-25”, product of OKADA SEIKO CO., LTD.). Thereafter, the magnetic carrier cores coated with the aforementioned coating liquid (L2) were baked at 220° C. for 1 hour. Thus, a fluororesin carrier was obtained. The mass (150 g) of the coat layers relative to 100 parts by mass (10,000 g) of the carrier cores was 1.5 parts by mass.

### <Two-Component Developer Preparation>

According to a combination indicated below in Table 2, 8 parts by mass of a toner (specifically, any of the toners (A) to (L)) and 100 parts by mass of a carrier (specifically, the silicone resin carrier or the fluororesin carrier) were mixed for 30 minutes using a shaker mixer (“TURBULA (registered Japanese trademark) MIXER T2F”, product of Willy A. Bachofen AG (WAB)). Thus, two-component developers (toner concentration 8% by mass) of Examples 1 to 5 and Comparative Examples 1 to 8 were obtained.

In Table 2 below, “St rate” refers to the rate of styrene to 100% by mol of the total of styrene and methyl methacrylate. “Amount added” refers to the content of the specific resin particles relative to 100 parts by mass of the toner mother particles. “Diameter” refers to the number average primary particle diameter. “Crosslink” refers to the presence or absence of a crosslinking structure (specifically, a repeating unit derived from ethylene glycol dimethacrylate) in the specific resin particles. “Silicone” under “Carrier” refers to the silicone resin carrier. “Fluororesin” under “Carrier” refers to the fluororesin carrier.

TABLE 2

| | Toner | | | | | | |
|---|---|---|---|---|---|---|---|
| | | Specific resin particles | | | | | |
| | | | St rate | | Diameter | Amount added | |
| | Type | Type | [% by mol] | Crosslink | [nm] | [part by mass] | Carrier |
| Example 1 | A | a | 30 | Present | 40 | 0.6 | Silicone |
| Example 2 | B | b | 60 | Present | 100 | 1.0 | Silicone |
| Example 3 | C | c | 60 | Present | 100 | 1.0 | Silicone |
| Example 4 | D | d | 28 | Present | 100 | 1.0 | Silicone |
| Example 5 | E | e | 62 | Present | 40 | 0.6 | Silicone |
| Comparative Example 1 | F | f | 60 | Present | 35 | 1.0 | Silicone |
| Comparative Example 2 | G | g | 30 | Present | 105 | 0.6 | Silicone |
| Comparative Example 3 | H | a | 30 | Present | 40 | 0.5 | Silicone |
| Comparative Example 4 | I | b | 60 | Present | 100 | 0.5 | Silicone |
| Comparative Example 5 | J | a | 30 | Present | 40 | 1.1 | Silicone |
| Comparative Example 6 | K | b | 60 | Present | 100 | 1.1 | Silicone |
| Comparative Example 7 | A | a | 30 | Present | 40 | 0.6 | Fluororesin |
| Comparative Example 8 | L | h | 30 | Absent | 40 | 0.6 | Silicone |

Evaluation of charge stability and measurement of contaminated resin particles were performed on the two-component developers of Examples 1 to 5 and Comparative Examples 1 to 8 by the following methods. The evaluation results and measurement results are shown below in Table 3.

### [Evaluation Apparatus]

As an evaluation apparatus, a multifunction peripheral (“TASKALFA 5550ci”, product of KYOCERA Document Solutions Japan Inc.) was used. A two-component developer (specifically, any of the two-component developers of Examples 1 to 5 and Comparative Examples 1 to 8) being an evaluation target was loaded into a development device for cyan developer of the evaluation apparatus. In addition, a toner (specifically, the same toner as the toner contained in the two-component developer being the evaluation target) was loaded into a toner container for cyan toner of the evaluation apparatus.

### [Recording Medium]

As a recording medium, A4-size plain paper (“COLOR COPY (registered Japanese trademark)”, product of Mondi Paper Sales GmbH) was used.

### [Measurement of Initial Amount of Charge]

Prior to the later-described printing durability test, 0.10 g of the two-component developer being the evaluation target was taken out of the development device for cyan developer of the evaluation apparatus. The taken-out two-component developer being the evaluation target was put into a measurement cell of a Q/m meter (“MODEL 212HS”, product of TREK, INC.). While only the toner of the two-component developer was sucked through a sieve (metal net) for 10 seconds, the amount [μC/g] of charge of the toner was measured using the Q/m meter. The measurement value was taken to be an initial amount Q_{A} of charge of the toner contained in the two-component developer being the evaluation target. Note that the amount of charge of the toner can be calculated using a formula “(amount of charge of toner)=(total electricity amount [μC] of sucked toner)/(mass [g] of sucked toner)”.

### [Printing Durability Test]

Using the evaluation apparatus, a white image (printing rate: 0%) was consecutively printed on the recording medium for 30 minutes in an environment at a temperature of 25° C. and a relative humidity of 50%. In the manner described above, the development device for cyan developer of the evaluation apparatus was continuously driven for 30 minutes.

### [Measurement of Amount of Charge After Printing Durability Test]

After the printing durability test, 0.10 g of the two-component developer being the evaluation target was taken out of the development device for cyan developer of the evaluation apparatus. The amount [μC/g] of charge of the toner contained in the taken-out two-component developer being the evaluation target after the printing durability test was measured by the same method as that for measuring the initial amount of charge described above. The measurement value was taken to be a post-printing durability test amount Q_{B} of charge of the toner contained in the two-component developer being the evaluation target.

### [Toner Charge Stability]

Toner charge stability was evaluated based on a difference Δ, which is an absolute value of (|Q_{A}−Q_{B}|) of the difference between the initial amount Q_{A} of charge and the post-printing durability test amount Q_{B} of charge. The criteria of toner charge stability are indicated below.

### (Criteria of Toner Charge Stability)

A (particularly good): difference Δ of no greater than 2.0 μC/g
B (good): difference Δ of greater than 2.0 μC/g and no greater than 3.0 μC/g
C (poor): difference Δ of greater than 3.0 μC/g

### [Percentage Content of Contaminated Resin Particles]

The percentage content of the contaminated resin particles in the carrier particles of each of the two-component developers of Examples 1 to 5 and Comparative Examples 1 to 8 was measured by the following method. After the printing durability test, the two-component developer was taken out of the development device for cyan developer of the evaluation apparatus. Next, the carrier was separated from the two-component developer using a 795-mesh sieve (opening 16 μm) to obtain a measurement carrier. GC/MS analysis was performed on the obtained measurement carrier to plot a GC/MS mass spectrum. Thereafter, quantification was performed on specific resin particles (i.e., contaminated resin particles) attached to the surfaces of carrier particles as a result of their detachment from the toner mother particles during the driving of the development device for cyan developer. The conditions for the GC/MS analysis and the quantification method for the contaminated resin particles were as follows.

### [Conditions for GC/MS Analysis]

As measuring devices, a gas chromatograph mass spectrometer (“GCMS-QP 2010 ULTRA”, product of Shimadzu Corporation) and a multi-shot pyrolyzer (“PY-3030D”, product of Frontier Laboratories Ltd.) were used. The column used was a GC column (“AGILENT (registered Japanese trademark) J&W ULTRA INERT CAPILLARY GC COLUMN DB-5 ms”, product of Agilent Technologies, Inc., phase: arylene phase with siloxane polymer main change reinforced by adding arylene to the polymer, inner diameter: 0.25 mm, film thickness: 0.25 μm, length: 30 m). The GC/MS analysis was performed on 100 μg of a measurement target (measurement carrier) under the following conditions to plot a mass spectrum (horizontal axis: (mass of ions)/(number of electrical charges of ions), vertical axis: detection intensity) including a peak derived from the contaminated resin particles.
Thermal decomposition temperature: heating furnace “600° C.”, interface site “320° C.”
Temperature rising conditions: Temperature was increased to 320° C. from 40° C. at a rate of 28° C./min, and kept at 320° C. for 5 minute.
Carrier gas: helium (He) gas (linear velocity 36.1 cm/min)
Column head pressure: 49.7 kPa
Injection mode: split injection (split ratio 1:200)
Carrier flow rate: total flow rate “204 mL/min”, column flow rate “1 mL/min”, purge flow rate “3 mL/min”

The amount of the contaminated resin particles per 1 g of the measurement carrier was obtained based on the mass spectrum (GS/MS mass spectrum) plotted for the measurement carrier by the above-described GC/MS analysis. In detail, an amount Y_{A} [g] of the contaminated resin particles contained in the measurement carrier was obtained from the measured peak area of the contaminated resin particles using a pre-plotted calibration curve (calibration curve indicating the relationship between the peak area of the GC/MS mass spectrum and the amount of the specific resin particles). Thereafter, a percentage content Y_{T} [% by mass] of the contaminated resin particles was calculated from an amount Y_{B} [g] of the measurement carrier used in the measurement and the amount Y_{A} of the contaminated resin particles obtained as above using a formula “Y_{T}=100×Y_{A}/Y_{B}”. The yardstick percentage contents of the contaminated resin particles are indicated below.

### (Yardstick Percentage Contents of Contaminated Resin Particles)

A (highly desirable): at least 0.005% by mass and no greater than 0.050% by mass
B (desirable): greater than 0.050% by mass and no greater than 0.100% by mass
C (undesirable): less than 0.005% by mass or greater than 0.100% by mass

TABLE 3

| | Contaminated resin particles | | | | | |
|---|---|---|---|---|---|---|
| | Amount of | | Charge stability | | | |
| | contaminant | | Q_{A} | Q_{B} | Difference Δ | |
| | [% by mass] | Rating | [μC/g] | [μC/g] | [μC/g] | Rating |
| Example 1 | 0.005 | A | 31.1 | 29.3 | 1.8 | A |
| Example 2 | 0.100 | B | 31.2 | 29.4 | 1.8 | A |
| Example 3 | 0.096 | B | 30.2 | 28.2 | 2.0 | A |
| Example 4 | 0.075 | B | 31.3 | 28.8 | 2.5 | B |
| Example 5 | 0.018 | A | 30.1 | 27.5 | 2.6 | B |
| Comparative Example 1 | 0.004 | C | 31.5 | 28.4 | 3.1 | C |
| Comparative Example 2 | 0.105 | C | 30.4 | 27.0 | 3.4 | C |
| Comparative Example 3 | 0.003 | C | 30.3 | 27.0 | 3.3 | C |
| Comparative Example 4 | 0.057 | B | 30.2 | 27.0 | 3.2 | C |
| Comparative Example 5 | 0.014 | A | 31.8 | 28.5 | 3.3 | C |
| Comparative Example 6 | 0.102 | C | 31.5 | 28.1 | 3.4 | C |
| Comparative Example 7 | 0.104 | C | 31.2 | 27.7 | 3.5 | C |
| Comparative Example 8 | 0.107 | C | 31.1 | 27.2 | 3.9 | C |

As shown in Tables 1 to 3, the two-component developers of Examples 1 to 5 each contained a carrier containing carrier particles and a toner containing toner particles. The carrier particles each included a carrier core and a coat layer covering the surface of the carrier core. The coat layers contained a silicone resin. The toner particles each included a toner mother particle and an external additive attached to the surface of the toner mother particle. The external additive contained the specific resin particles. The specific resin particles contained a crosslinked resin. The specific resin particles had a number average primary particle diameter of at least 37 nm and no greater than 103 nm. The specific resin particles had a content of at least 0.6 parts by mass and no greater than 1.0 part by mass relative to 100 parts by mass of the toner mother particles. Note that the carrier particles of each of the two-component developers of Examples 1 to 5 further contained contaminated resin particles attached to the surfaces of the coat layers thereof. The contaminated resin particles had a percentage content of at least 0.005% by mass and no greater than 0.100% by mass in the carrier particles. The two-component developers of Examples 1 to 5 were excellent in toner charge stability.

By contrast, the two-component developer of Comparative Example 1 contained specific resin particles with a number average primary particle diameter of less than 37 nm. The specific resin particles of the two-component developer of Comparative Example 1 are thought to be easily buried in the toner mother particles. As a result, the two-component developer of Comparative Example 1 was rated as poor in toner charge stability.

The two-component developer of Comparative Example 2 contained specific resin particles with a number average primary particle diameter of greater than 103 nm. The specific resin particles of the two-component developer of Comparative Example 2 are thought to be easily detached from the toner mother particles. As a result, the two-component developer of Comparative Example 2 was rated as poor in toner charge stability.

The two-component developers of Comparative Examples 3 and 4 each contained specific resin particles with a percentage content of less than 0.6 parts by mass relative to 100 parts by mass of the toner mother particles. The two-component developers of Comparative Examples 3 and 4 were rated as poor in toner charge stability due to a shortage in the amount of the specific resin particles that contribute to charge stability.

The two-component developers of Comparative Examples 5 and 6 each contained specific resin particles with a percentage content of greater than 1.0 part by mass relative to 100 parts by mass of the toner mother particles. The specific resin particles of the two-component developers of Comparative Examples 5 and 6 were thought to be easily detached from the toner mother particles due to their excessive amount. Detachment of the specific resin particles from the toner mother particles is thought to change the amount of charge of the toner. It is also thought that the specific resin particles detached from the toner mother particles are attached to the surfaces of the carrier particles, leading to contamination of the carrier. As a result, the two-component developers of Comparative Examples 5 and 6 were rated as poor in toner charge stability.

The two-component developer of Comparative Example 7 contained the fluororesin carrier as a carrier. The fluororesin carrier is more likely to attach to the surfaces of the carrier particles than the silicone resin carrier. Therefore, it is thought that the specific resin particles of the two-component developer of Comparative Example 7 that have separated from the toner mother particles are likely to be attached to the surfaces of the carrier particles. As a result, the two-component developer of Comparative Example 7 was rated as poor in toner charge stability.

The two-component developer of Comparative Example 8 contained resin particles containing a non-crosslinked resin as the specific resin particles. The resin particles such as those containing a non-crosslinked resin have low strength and are therefore considered incapable of performing a sufficient spacer function. As a result, the two-component developer of Comparative Example 8 was rated as poor in toner charge stability.

What is claimed is:

1. A two-component developer comprising:
a carrier containing carrier particles; and
a toner containing toner particles, wherein
the carrier particles each include a carrier core and a coat layer covering a surface of the carrier core,
the coat layers contain a silicone resin,
the toner particles each include a toner mother particle and an external additive attached to a surface of the toner mother particle,
the external additive contains specific resin particles,
the specific resin particles contain a crosslinked resin,
the specific resin particles have a number average primary particle diameter of at least 37 nm and no greater than 103 nm, and
the specific resin particles have a content of at least 0.6 parts by mass and no greater than 1.0 part by mass relative to 100 parts by mass of the toner mother particles.

2. The two-component developer according to claim 1, wherein
the crosslinked resin include a first repeating unit derived from a styrene compound and a second repeating unit derived from (meth)acrylic acid compound, and
in the crosslinked resin, the first repeating unit has a percentage content of at least 29% by mol and no greater than 61% by mol to 100% mol of total of the first repeating unit and the second repeating unit.

3. The two-component developer according to claim 1, wherein
the crosslinked resin is a copolymer of styrene, methyl methacrylate, and ethylene glycol dimethacrylate.

4. The two-component developer according to claim 1, wherein
the toner particles each further include an ionic surfactant attached to surfaces of the specific resin particles.

5. The two-component developer according to claim 4, wherein
the ionic surfactant includes a cationic surfactant.

6. The two-component developer according to claim 1, wherein
the coat layers further contain metal oxide particles or carbon black particles.

7. A two-component developer comprising:
a carrier containing carrier particles; and
a toner containing toner particles, wherein
the carrier particles each include a carrier core and a coat layer covering a surface of the carrier core,
the coat layers contain a silicone resin,
the toner particles each include a toner mother particle and an external additive attached to a surface of the toner mother particle,
the external additive contains specific resin particles,
the specific resin particles contain a crosslinked resin,
the specific resin particles have a number average primary particle diameter of at least 37 nm and no greater than 103 nm,
the specific resin particles have a content of at least 0.6 parts by mass and no greater than 1.0 part by mass relative to 100 parts by mass of the toner mother particles,
the carrier particles each further include contaminated resin particles attached to a surface of the coat layer, and
the contaminated resin particles have a percentage content of at least 0.005% by mass and no greater than 0.100% by mass in the carrier particles.
